(19) United States
(12) Patent Application Publication
(10) Pub. No.: US 2005/0116682 A1
(43) Pub. Date: Jun. 2, 2005

(54) Low voltage protection device for batteries

(75) Inventors: Chien-Tsung Wu, Hsinchu (TW); Hsing-Ming Su, KaoHsiung (TW); Shih-Ming Lo, Hsinchu (TW); Yin-Kun Huang, Hsinchu (TW)

Correspondence Address: BRUCE H. TROXELL, SUITE 1404, 5205 LEESBURG PIKE, FALLS CHURCH, VA, 22041, US

(73) Assignee: INDUSTRIAL TECHNOLOGY RESEARCH INSTITUTE

(21) Appl. No.: 10/793,781

(22) Filed: Mar. 8, 2004

(30) Foreign Application Priority Data
Dec. 2, 2003 (TW) 92133774

(51) Int. Cl. H02J 7/00

(52) U.S. Cl. 320/107

(57) ABSTRACT

The present invention discloses a low voltage protection device for batteries, comprising a load, being a motor for employing as a power source of a vehicle; a secondary battery, having a rechargeable feature and providing power to said load; a low voltage protection circuit, capable of turning on/off the circuit between said load and said secondary battery; a low voltage detection circuit, for outputting a current for switching said low voltage protection circuit to an off state when the voltage of said secondary battery being detected is lower than a predetermined voltage; and a non-retaining start button, for driving said low voltage protection circuit to activate said connect said low voltage protection circuit while pressing the same to connect said load with said secondary battery.

### FIELD OF THE INVENTION

The present invention relates to a low voltage protection device for batteries, more particularly to a voltage protect circuit of a secondary battery used as automobile battery, which is capable of preventing damages to the secondary battery when the voltage is too low.

### BACKGROUND OF THE INVENTION

As to the development trend of transportation means, such as automobiles and motor cycles, besides boosting the horsepower and adding luxurious equipments to the interior of the automobile, reducing air pollution caused by exhaust emissions is also a key topic for the research and development to cope with the present promotion of environmental protection. In addition to the replacement of the carburetor for present motor vehicles by the fuel injection pump to reduce pollution, researches and developments are preformed to provide an electric power motor vehicles and motorcycles as an ultimate solution to the air pollution problem. Many types of motor vehicles including electric power automobiles, motorcycles, and hybrid motor vehicles, etc use rechargeable battery as its power source, and the types of rechargeable batteries (also known as secondary battery) generally include lead acid battery, nickel-cadmium battery, Nickel Metal-Hydride battery, lithium ion battery, and lithium polymer battery, etc. Besides the rechargeable feature, these batteries also may cause damages for its low voltage after being electrically discharged. Therefore, attention should be paid to this issue.

In a general conventional control system of electric power automobile, the motor driving controller will automatically stop the motor or directly disconnect the power to the motor driving controller so as to stop the motor, when the voltage of the foregoing secondary battery is found too low. Such arrangement can prevent the secondary battery from being over-discharged and causing damages to the battery.

The prior art such as the R.O.C. Utility Patent No. 311740, entitled “Over-discharge Prevention Device for battery for Electric Vehicles” and issued to Honda Motor Company, discloses an over-discharge prevention device. That is, when the voltage of the power source, i.e. a second battery pack, of an electric power vehicle is too low, the DC converter will be driven to stop outputting the secondary side voltage so as to cut off the output of the secondary battery pack, so that the motor driving controller is disconnect for preventing a continual power consumption of the secondary battery. However, when such technological measure is taking place, the DC power supply is still electrically connected to the secondary battery pack, and the DC power supply will still consumes electric power of the exhausted second battery pack that a period of time later, the secondary battery will be damaged since the voltage thereof is too low. The present invention can overcome such shortcoming and extend the life of the secondary battery.

### SUMMARY OF THE INVENTION

The primary object of the present invention is to provide a low voltage protection device for batteries, comprising a low voltage detection circuit, a protect circuit consisted of two relay switches, and a non-retaining start button. The present invention needs no microprocessor for any computation, and thus can effectively reduce the manufacturing cost and have a simple and accurate structured mechanism for preventing damages to the secondary battery when the voltage is too low.

### BRIEF DESCRIPTION OF THE DRAWINGS

FIG. 1 is a view of the low voltage protection device for batteries according to a preferred embodiment of the present invention.

FIG. 2 is a view of the low voltage protection device for batteries according to another preferred embodiment of the present invention.

### DESCRIPTION OF THE PREFERRED EMBODIMENT

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

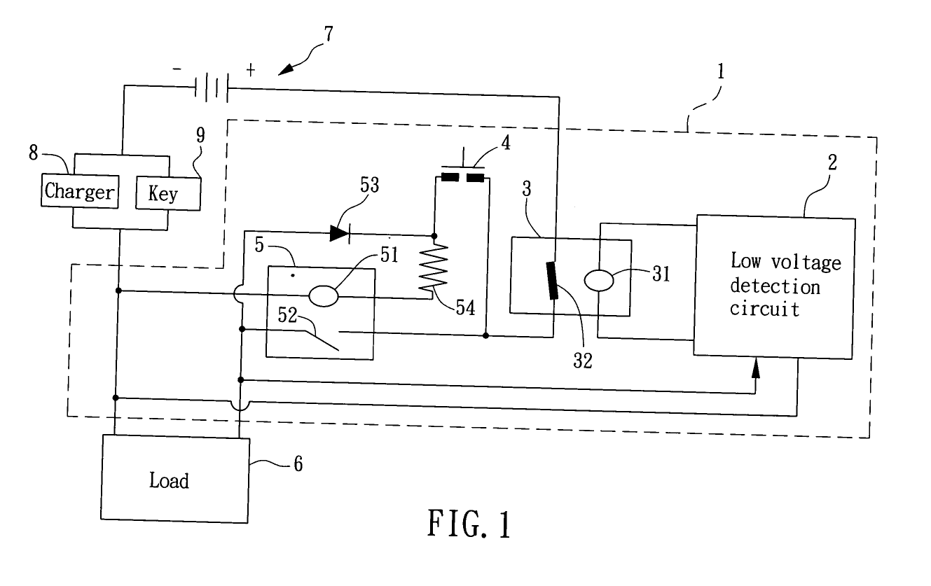

Please refer to FIG. 1 for the low voltage protection device for batteries according to the first preferred embodiment of the present invention. The circuit of the embodiment comprises a secondary battery 7, a load 6, a low voltage detection circuit 2, a low voltage protection circuit 1 (including a normally open relay 5 and a normally closed relay 3 which can be a transistor), and a non-retaining start button 4.

The principle of the actions as depicted in FIG. 1 is elaborated below:

(1) As the system is ready to start, charger 8 is electrically connected or a key 9 is turned on. Wherein, the charger 8 is used to charge the secondary battery, and a key slot works correspondingly with the key as a start switch for the whole circuit. The functions of the charger 8 and the key 9 are known to those skilled in the art and thus will not be described here.

(2) As the non-retaining start button 4 is pressed for conducting current, current will flow from the anode of the secondary battery 7 through the normally closed relay 3 to the non-retaining start button 4 which is in conductive state, and then is fed into a current-limiting resistor 54 to flow through an field coil 51 of the normally open relay 5 and finally back to the cathode of the battery 7. Wherein, the secondary battery 7 could be a lead acid battery, a nickel cadmium battery, a nickel metal-hydride battery, a lithium ion battery, or a lithium polymer battery.

(3) As current is flowing through the field coil 51 of the normally open relay 5, the normally open contact 52 in the normally open relay 5 is turned on for electrically connecting the circuits respectively disposed at the two ends of the relay 5, and a diode 53 is disposed between the normal open contact point 52 and the field coil 51 to protect the normal open relay 5 from being damaged by a reverse current.

(4) Then, the current can be divided into two paths. One path flows from the anode of the secondary battery 7 through the normally closed relay 31 and then flows through the normal open contact point 52 of the normally open relay 5, and then through the load 6 back to the cathode of the secondary battery 7, and the other path flows from the anode of the secondary battery 7 through the normally closed relay 3, the normal open contact point 52 of the normal open relay 5, the diode 53, the limiting-current resistor 54, the field coil 51 and the key 9, then back to the cathode of the secondary battery 7 to constitute a self-retaining circuit of the field coil 51 of the normally closed relay 51.

(5) When the voltage of the secondary battery 7 drops to the predetermined voltage, the low voltage detection circuit 2 will be connected electrically to the field coil 31 of the normally closed relay 3, and the normally closed switch 32 of the normal close relay 3 will be switched to the OFF state. In the meantime, the normally open contact 52 of the normal open relay 3 will be switched from the self-retaining ON state to the OFF state, and thus totally disconnecting the output circuit of the secondary battery 7. The foregoing low voltage detection circuit 2 is consisted of an OP comparison circuit having an input set to a predetermined voltage. If the voltage of the secondary battery is lower than the predetermined voltage, then a current will be outputted to the low voltage protect circuit for enabling a disconnection. The foregoing OP comparison circuit is known to those skilled in the art and thus will not be described here.

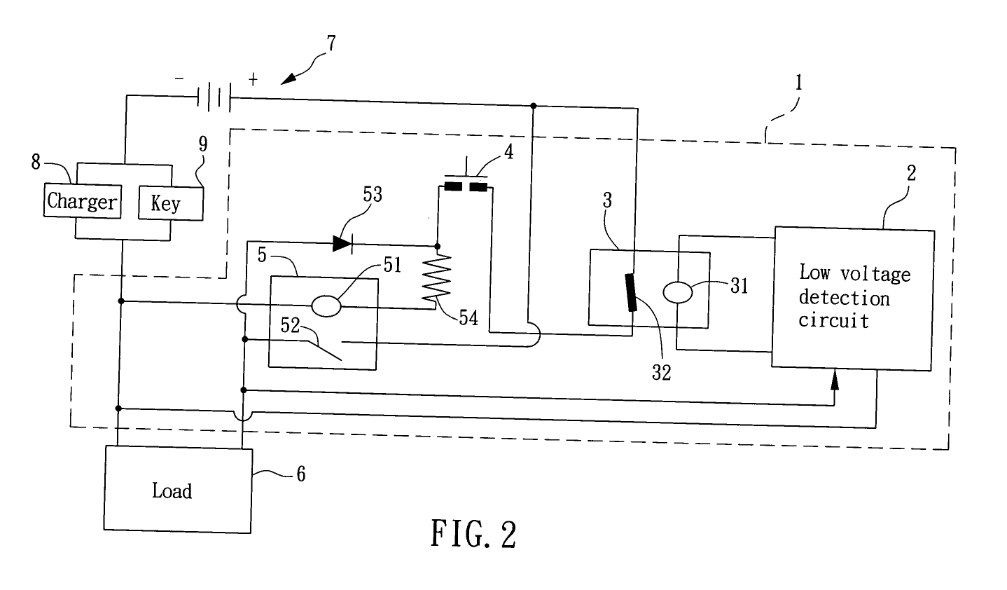

Please refer to FIG. 2 for the low voltage protection device of another preferred embodiment of the present invention. Compared with the circuitry in FIG. 1, the design of the circuit is changed, such that the normally closed contact 32 of the normally closed relay 3 is not coupled directly to the normally open contact 52 of the normally open relay 5, and when the secondary battery 7 is discharging electricity, the current will not pass through the normally closed relay 3. Therefore, a small normally closed relay 3 or a transistor (switch with smaller power) can be employed instead of a normally closed relay 3 that uses more power to accomplish the same effect. Such arrangement can also prevent damages caused by a larger power consumption of the load.

The principle of the actions taken by the circuit depicted in FIG. 2 is described below:

(1a) When the system is ready to start, a charger 8 is electrically connected or a key 9 is turned on.

(2a) As the non-retaining start button 4 is pressed for conducting current, current will flow from the anode of the secondary battery 7 through the normally closed relay 3 to the non-retaining start button 4 which is in conductive state, and then is fed into a current-limiting resistor 54 to flow through an field coil 51 of the normally open relay 5 and finally back to the cathode of the battery 7.

(3a) As current is flowing through the field coil 51 of the normally open relay 5, the normally open contact 52 in the normally open relay 5 is turned on for electrically connecting the circuits respectively disposed at the two ends of the relay 5

(4a) Then, the current can be divided into two paths. One path flows from the anode of the secondary battery 7 through the normally open contact 52 of the normally open relay 5 and then the load 6 and the key 9, and then back to the cathode of the secondary battery 7, and the other path flows from the anode of the secondary battery 7 through the normally open relay 5, the normally open contact 52 of the normally open relay 5, the diode 53, the current-limiting resistor 54, the field coil 51 and the key 9 of the normally open relay 5 back to the cathode of the secondary battery 7 to constitute a self-retaining circuit of the field coil 51 of the normally open relay 5.

(5a) When the voltage of the secondary battery 7 drops to the predetermined voltage, the low voltage detection circuit 2 will be connected electrically to the field coil 31 of the normally closed relay 3, and the normally closed switch 32 of the normal close relay 3 will be switched to the OFF state. In the meantime, the normally open contact 52 of the normal open relay 3 will be switched from the self-retaining ON state to the OFF state, and thus totally disconnecting the output circuit of the secondary battery 7.

By means of the actions and procedures taken for the circuit as shown in FIGS. 1 and 2, a low voltage protection is accomplished, so that the whole circuit will not consume any power of the secondary battery while low voltage is detected. Since the structure of the embodiment needs no microprocessor for any computation, therefore it can effectively lower the manufacturing cost. In addition, the circuit has a simple structure and an accurate mechanism for preventing damages to the secondary battery when the voltage is too low.

In summation of the above description, the present invention herein enhances the performance than the conventional structure and further complies with the patent application requirements and is submitted to the Patent and Trademark Office for review and granting of the commensurate patent rights.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A low voltage protection device for batteries, comprising:
a load, being a motor for employing as a power source of a vehicle;
a secondary battery, having a rechargeable feature and providing power to said load;
a low voltage protection circuit, capable of turning on/off the circuit between said load and said secondary battery;
a low voltage detection circuit, for outputting a current for switching said low voltage protection circuit to an off state when the voltage of said secondary battery being detected is lower than a predetermined voltage; and
a non-retaining start button, while pressing the same to connect said load with said secondary battery.

2. The low voltage protection device for batteries of claim 1, wherein said low voltage protect circuit comprises:
a normally open relay, being corresponsive to said non-retaining start button, capable of exciting said field coil in said normally open relay so as to keep the normally open contact of the same in the on state for electrically connecting the circuits disposed at the two ends of the relay when said non-retaining start button is pressed; and
a normally closed relay, being corresponsive to a current outputted by said low voltage detection circuit for switching said low voltage protection circuit to the off state.

3. The low voltage protection device for batteries of claim 2, wherein said normally open relay comprises a diode disposed between said normally open contact and said field coil for protecting said normally open relay from being damaged by a reverse current.

4. The low voltage protection device for batteries of claim 2 further comprising a current-limiting resistor disposed between said normally open relay and said non-retaining start button.

5. The low voltage protection device for batteries of claim 1, wherein said low voltage protect circuit comprises:
a first normally open relay, being corresponsive to said non-retaining start button, capable of exciting said field coil in said normally open relay so as to keep the normally open contact of the same in the on state for electrically connecting the circuits disposed at the two ends of the relay when said non-retaining start button is pressed; and
a second normally closed relay, being corresponsive to a current outputted by said low voltage detection circuit for switching said low voltage protection circuit to the off state.

6. The low voltage protection device for batteries of claim 5, wherein said first normally open relay comprises a diode disposed between said normal open contact and said field coil, for protecting said normally open relay from being damaged by a reverse current.

7. The low voltage protection device for batteries of claim 1, wherein said low voltage detection circuit is consisted of an OP comparison circuit, and a predetermined voltage is defined by using an input of said OP comparison circuit, wherein when the voltage of said secondary battery is lower than said predetermined voltage, a current is outputted for switching said low voltage protection circuit to the off state.

8. The low voltage protection device for batteries of claim 1, wherein said secondary battery is one of the following: a lead acid battery, a nickel cadmium battery, a nickel metal-hydride battery, a lithium ion battery, and a lithium polymer battery.

9. The low voltage protection device for batteries of claim 1, wherein said low voltage protection circuit further comprises a charger for charging said secondary battery.

10. The low voltage protection device for batteries of claim 1, wherein the circuit of said low voltage protection device further comprises a key slot corresponding to a key for turning on/off said circuit.
